(19) United States
(12) Patent Application Publication
(10) Pub. No.: US 2025/0352903 A1
(43) Pub. Date: Nov. 20, 2025

(54) SYSTEMS AND METHODS FOR CONVERTING A FILE INTO A HARDWARE-AGNOSTIC UNIVERSAL HAPTIC FILE

(71) Applicant: Meta Platforms Technologies, LLC, Menlo Park, CA (US)

(72) Inventors: Maximilian Weber, Berlin (DE); Daniel Büttner, Berlin (DE); Gwydion ap Dafydd, Bießen am Ammersee (DE)

(21) Appl. No.: 18/059,959

(22) Filed: Nov. 29, 2022

Related U.S. Application Data
(60) Provisional application No. 63/283,882, filed on Nov. 29, 2021.

(51) Int. Cl. A63F 13/54; A63F 13/285; H04R 1/10

(52) U.S. Cl. CPC A63F 13/54; A63F 13/285; G06F 3/165

(57) ABSTRACT

Different embodiments of the present invention provide methods and systems for converting a file or a compressed or uncompressed audio signal into a universal haptic file format. The universal haptic file format can be executed on different hardware to produce immersive haptic effect. The method and system for file format convertor analyzes the audio signal or identifies the type and format of the file. The system and method then analyzes the audio signal to break it into the amplitude time values, frequency time values and amplitude frequency time values for each frequency band. When the input is the file, it is passed to a transcription module, which determines if the file can be transcript into the universal haptic file format. If so, the transcription module transcripts the haptic file into the universal file format and pass it to a file validation module. The file validation module then scan and transcript haptic file to ensure that the time amplitude frequency values for different frequency bands have been included and produce a universal haptic file. If the haptic file contains metadata and the transcription module determines that the haptic file cannot be converted by transcription then the file format convertor uses the metadata modules to extract metadata and associated haptic values to be converted into time amplitude frequency values, which is then passed to the file validation module for validation.

### RELATED APPLICATION

This application claims priority from U.S. Provisional Application No. 63/283,882, which is hereby incorporated by reference in its entirety.

### TECHNICAL FIELD

The technical field relates to a haptic processing method and system for generation of haptic data using a universal file format. More specifically, the technical field relates to analyzing audio signals stored in one file format to prepare a representation of those audio signals for use in producing haptic output, the representation being stored using a universal file format, which can be used to produce haptic output on multiple devices with different hardware and software configuration.

### BACKGROUND

A haptic output (or simply a haptic) usually refers to a sense of touch or perception provided to a user as a feedback force or vibration received for a device (such as a handheld device or a body-worn device). An electronic computing device with haptic feedback can substantially improve a human-computer interface. The haptic feedback provides a sense of perception of touch and feel, which can enhance the user experience. The haptic feedback provided by the different types of devices is distinguishable, providing a sense of different feel and touch. However, due to lack of standardization, there is no interoperability of haptic output on different devices. To address this issue, the invention converts discreet file formats, such as pulse-code modulation (PCM) data, to a universal, hardware-agnostic file format that can be executed on multiple devices.

This issue exists in part because a complex process can be required to enable substantially (perceptionally) similar haptic effects on different devices. With differences in hardware and software used for processing and/or converting an audio signal into haptic data and for playing back haptics on a hardware device, it i extremely difficult to use one haptic file format to produce haptic outputs on multiple devices with different hardware and software.

To help allow for the use of a single file format on multiple devices, the techniques discussed herein propose a universal file format and a process of creating the universal file format that can be embedded in a haptic device or may be provided offline for conversion. These novel techniques provide unique methods and systems of using a single haptic file on multiple devices with different hardware.

### SUMMARY

Aspects of the techniques and embodiments described herein are briefly summarized below, followed by a brief description of the drawings, and then the detailed description. In one aspect, a method of converting a file or an audio signal or a discreet signal (PCM, encoded audio or haptic signal) into a universal haptic file format is provided. The method comprising: analyzing content of the file or the audio signal to determine a type and a format of the file or the audio signal, wherein the identification of the type and format of the file includes analyzing structure and data values of the file or the audio signal. The method also includes analyzing the audio signal using a signal-analysis module or the file using a transcription module; passing the file to the transcription module having a transcription processor or a signal analysis module having a signal processor to evaluate the type and the format to determine if a conversion into the universal haptic file format requires transcription (e.g., of encoded data) or a metadata analysis. And, if the conversion is determined to require transcription, then the method includes extracting haptic data to convert the file into the universal haptic file format. If the conversion is determined to not require transcription, then the method includes passing the file to a metadata module having a processor to extract metadata and metadata values from the file to convert it into the universal haptic file format and analyzing time amplitude frequency values for each frequency band to validate the conversion of the file into the universal haptic file format.

In some embodiments, the signal analysis module comprises a time amplitude module, a time frequency module, a transient analysis module for each frequency band (e.g., each frequency band associated with data in the audio signal).

In some embodiments, the method of converting the file or the audio signal (which audio signal can also be stored in a discreet file) into the universal haptic file format includes transcripting of an input file into both (i) haptic data and (ii) transient data.

In some embodiments, the metadata module includes a metadata analyzer and a metadata extractor.

In some embodiments, the method includes using a file validation module to validate and append time amplitude frequency values, amplitude time values, and frequency time values for each frequency band (e.g., each frequency band associated with data in the audio signal) using interpolation models.

Systems implementing the methods discussed herein can also be provided. As one example, a haptic file conversion system for converting a data file or an audio signal into a universal haptic file format is provided. The haptic file conversion system comprising: a file identifier and analysis module for analyzing a type, content, and a format of the data file, wherein the identification of the type, the content, and the format of the file includes analyzing structure and data values of the file. The haptic file conversion system also includes a transcription module having a transcription processor to evaluate the type and the format and to determine if conversion into the universal haptic file format requires transcription or metadata analysis. If the haptic file conversion is determined by the system to require transcription, then the transcription module can be configured to extract haptic data to convert the file into the universal haptic file format. If the haptic file conversion is determined by the system to not require transcription (or is determined to require metadata analysis instead of transcription), then the haptic file conversion system can be configured to pass the file to a metadata module comprising a metadata analyzer for analyzing a type of metadata and a file metadata extractor for extracting the metadata and metadata values from the file to convert into universal haptic file format and a file validation module for analyzing time amplitude frequency values, amplitude time values, frequency time values for each frequency band to validate the conversion of the file into the universal haptic file format.

In some embodiments, signal analysis of the audio signal can be performed by the haptic file conversion system, and the signal analysis includes analysis of a compressed or an uncompressed audio signal into amplitude time values, frequency time values, and amplitude frequency time values to produce an analyzed audio signal. The analyzed audio signal is configured to be passed to a data validation module for validation of haptic data. Finally, the haptic data after validation is produced in the universal haptic file format.

In some embodiments, the transcription module may include a transcription processor, which is configured to extract haptic data and transient data from the file.

In some embodiments, the metadata module may include a file metadata analyzer, which includes the file metadata extractor and a metadata processor.

In some embodiments, the haptic file conversion system includes a file validation module configured to validate and append the time amplitude frequency values for each frequency band using interpolation models.

Other example methods are also described herein. Another example method of converting a haptic file or compressed and uncompressed audio data into a universal haptic file format is thus also provided. The method comprising: analyzing the content to determine a type and a format of the haptic file or the compressed and uncompressed audio data, wherein identification of the type and the format of the haptic file includes analyzing structure and data values of the haptic file or the compressed and uncompressed audio data; passing the haptic file to a transcription processor or a signal analysis module to evaluate type, content, and format to determine if conversion into the universal haptic file format requires signal analysis, transcription, or metadata analysis, and if the haptic file conversion requires transcription then the method includes extracting the haptic data to convert the haptic file into time amplitude frequency values (which values can be associated with a harmonic component or a percussive component); else passing the haptic file to metadata processor to extract metadata and metadata values from the haptic file to convert into time amplitude frequency values into the harmonic component and the percussive component; analyzing the time amplitude frequency values for the harmonic component and the percussive component to validate the conversion of the haptic file into the universal haptic file format, and normalizing the universal haptic file format file format for an immersive haptic experience.

In some embodiments, the method includes using a file validation module to validate and append the time amplitude frequency values for the harmonic component and the percussive component. The file validation module may further include a residual component.

Another haptic file conversion system will now be briefly summarized. This haptic file conversion system is for converting a haptic file or audio data into a universal haptic file format. The haptic file conversion system comprising: a file identification and analysis module for analyzing type, content, and a format of the haptic file or the audio data, wherein the identification of the type, the content, and the format of the haptic file or the audio data includes analyzing structure and data values of the haptic file; analyzing the audio data using the signal analysis module or the haptic file using the transcription module; a transcription module having a transcription processor to evaluate the type and the format and to determine if conversion into the universal haptic file format requires transcription or metadata analysis, and if the conversion is determined to require transcription, then the haptic file conversion system can be configured to extract the haptic data to convert the haptic file into time amplitude frequency values for a harmonic component and a percussive component; else passing the haptic file to a metadata module comprising a metadata analyzer for analyzing a type of metadata and a file metadata extractor for extracting the metadata and metadata values from the haptic file to convert into time amplitude frequency values for a harmonic component and a percussive component; a file validation module for analyzing the time amplitude frequency values for the harmonic component and the percussive component to validate the conversion of the haptic file into the universal haptic file format, and normalizing the universal haptic file format file format for an immersive haptic experience.

In one other aspect, a method of converting a haptic file or an audio data into an universal haptic file format is provided. The method comprising: analyzing content to determine a type and a format of a haptic file or audio data, wherein the identification of type and format of the haptic file or the audio data includes analyzing structure and data values of the haptic file or the audio data; analyzing the audio data using a signal analysis module or the haptic file using a transcription module; passing the haptic file to a transcription processor (which can be a part of the transcription module) to evaluate the type and the format of the haptic file (and/or of a process used for the conversion) to determine if conversion into the universal haptic file format requires transcription or metadata analysis, and if the haptic file conversion is determined to require transcription, then the method includes extracting haptic data to convert the haptic file into the universal haptic file format; else passing the haptic file to a metadata processor to extract metadata and metadata values from the haptic file to convert into the universal haptic file format; accessing information related to one or more actuators associated with an electronic computing device to optimize a haptic experience (which can be provided using haptic data stored with the resulting universal haptic file format) based on at least one of a set of characteristics associated with operating the one or more actuators and the at least one characteristic of a computer game; analyzing time amplitude frequency values for each frequency band to validate the conversion of the haptic file into the universal haptic file format.

In some embodiments, each respective actuator of the one or more actuators is a linear resonant actuator (LRA), a voice coil, or a wideband actuator.

In some embodiments, a database is configured to dynamically receive information related to actuators available from different vendors. In some embodiments, the database may be a distributed database. The database can be used by the method to properly select which of the set of characteristics associated with operation of the one or more actuators used to help optimize the haptic file format.

One more haptic file conversion system will now be briefly summarized. This haptic file conversion system is for converting a haptic file into an universal haptic file format. The haptic file conversion system comprising: a file identifier and analysis module configured to identifying (which can also include analyzing) a type, content, and a format of the haptic file, wherein the identification of the type, the content, and the format of the haptic file includes analyzing structure and data values of the haptic file; a transcription module configured to evaluate the type and the format of the haptic file (and/or of a process used for the conversion) to determine if conversion into the universal haptic file format requires transcription or metadata analysis, and if the haptic file conversion is determined to require transcription, then the system can be configured to extract haptic data to convert the haptic file into the universal haptic file format; else passing the haptic file to a metadata processor (which can be a part of a metadata analysis module) configured to extract metadata and metadata values from the haptic file to convert into the universal haptic file format; a database for accessing information related to one or more actuators associated with an electronic computing device to optimize a haptic experience based on at least one of a set of characteristics associated with the one or more actuators and at least one of characteristic of a computer game; a file validation module for analyzing time amplitude frequency values for each frequency band to validate the conversion of the haptic file into the universal haptic file format.

In some embodiments, the database is configured to dynamically receive information related to actuators available from different vendors.

In yet another aspect, a method of converting a haptic file into an universal haptic file format is provided. The method comprising: analyzing the content to determine a type and a format of the haptic file, wherein the identification of the type and the format of the haptic file includes analyzing structure and data values of the haptic file; passing the haptic file to a transcription processor to evaluate the type and the format of the haptic file (and/or of a process used for the conversion) to determine if conversion into the universal haptic file format requires transcription or metadata analysis, and if the conversion is determined to require transcription, then extracting the haptic data to convert the haptic file into the universal haptic file format; else passing the haptic file to a metadata processor to extract metadata and metadata values from the haptic file to convert into the universal haptic file format; accessing information related to one or more actuators associated with an electronic computing device to optimize a haptic experience based on at least one of a set of characteristics associated with operating the one or more actuators and a characteristic of computer game; authoring a transient from an audio signal (e.g., one that might be stored on the haptic file and used to generate haptic data associated with and corresponding to the audio signal) to add transient data to the haptic data using a real-time audio stream associated with the haptic file, and analyzing time amplitude frequency values for each frequency band to validate the conversion of the haptic file into the universal haptic file format.

In some embodiments, the real time audio stream is synchronized with the haptic file.

In some embodiments, the authoring of the transient data is performed using a user interface.

In some embodiments, the authoring is enabled by machine-learning algorithms.

Yet one further system can also be provided. As such as, a haptic file conversion system is provided for converting a haptic file into an universal haptic file format. The haptic file conversion system comprising: a file identifier and analysis module configured to analyze a type, content, and a format of the haptic file, wherein the identification of the type, the content, and the format of the haptic file includes analyzing structure and data values of the haptic file; a transcription module configured to evaluate the type and the format of the haptic file (and/or of a process used for the conversion) to determine if the conversion into the universal haptic file format requires transcription or metadata analysis, and if the haptic file conversion requires transcription then extracting the haptic data to convert the haptic file into the universal haptic file format; else passing the haptic file to the metadata processor to extract metadata and meta data values from the haptic file to convert into universal haptic file format; a database for accessing information related to one or more actuators associated with an electronic computing device to optimize the haptic experience based on at least one of the characteristics of one or more actuators and the at least one of the characteristics of computer game; an authoring module for authoring the transient from the audio signal to add transient data to the haptic using real time audio signal associated with the haptic file, and a file validation module for analyzing the time amplitude frequency values for each frequency band to validate the conversion of the haptic file into the universal haptic file format.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the inventions are described below with reference to the drawings. The illustrated embodiments are intended to illustrate, but not to limit, the inventions. The drawings contain the following figures:

FIG. 1 illustrates an overview of an operating environment of a haptic processing system in accordance with an embodiment;

FIG. 2 illustrates different components of a haptic module in accordance with the embodiment;

FIG. 3 illustrates a haptic module operating in a distributed environment in accordance with another embodiment;

FIGS. 4A and 4B illustrate block diagrams of an aggregation and file management module in accordance with an embodiment;

FIGS. 5A-5B illustrate a process of converting a haptic file into a universal file format in accordance with an embodiment;

FIG. 6A illustrates a block diagram of a file format convertor in accordance with an embodiment;

FIG. 6B illustrates a block diagram of a file format convertor in accordance with another embodiment;

FIG. 7 illustrates a block diagram of a file format convertor in accordance with yet another embodiment;

FIGS. 8A and 8B illustrate block diagrams for haptic playback in accordance with an embodiment;

FIG. 9 illustrates a block diagram for haptic playback with optimized parameters in accordance with an embodiment; and

FIG. 10 illustrates a block diagram for haptic playback with added emphasis from a real-time audio stream in accordance with an embodiment.

### DETAILED DESCRIPTION

Reference will now be made to embodiments, examples of which are illustrated in the accompanying drawings. In the following description, numerous specific details are set forth to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

As used herein, the terms “input audio signal,” “received signal,” “processed signal,” and “audio signal” are intended to broadly encompass all types of audio signals, including an analog audio signal, digital audio signal, digital audio data, audio signal embedded in media programs including signal embedded in video or audio that can be rendered using a rendering device capable of reproducing any other type of audio or media program connected to a network or any electronic device operating independently. The terms also encompass live media, linear media, and interactive media programs such as music, games, online video games or any other type of streamed media programs with embedded audio. Furthermore, these terms also include an array of amplitude time values, an array of frequency time values, an array of amplitude frequency time values, an array of impulse sequence values to substantiate the contextual meaning at different places.

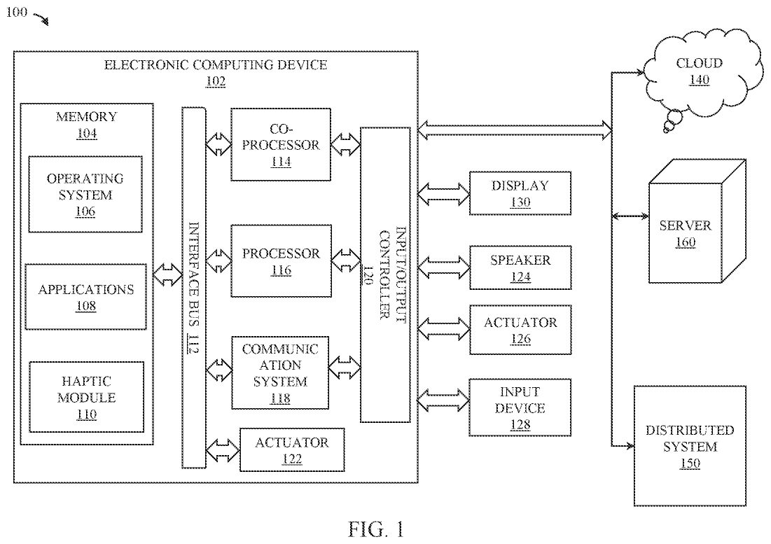

FIG. 1 illustrates an overview of an operating environment of a haptic processing system in accordance with an embodiment. The operating environment includes a haptic processing system 100, an electronic computing device 102 connected to a cloud 140, a distributed system 150, and a server 160, and each of these components can be in communication via a wired or wireless network. The operating environment 100 is exemplary and other variations may include different implementations with fewer or additional components.

The electronic computing device 102 includes a memory 104, a coprocessor 114, at least one processor 116, a communication system 118, an interface bus 112, an input/output controller 120, and one or more haptic actuators 122. In addition, one or more haptic actuators 126 may be associated with the electronic computing device 102. For example, a haptic actuator such as the actuator 126 may be embedded in a haptic vest directly associated with the electronic computing device 102. An interface bus 112 provides power and data communication to the memory 104, the processor 116, the coprocessor 114, the input/output controller 120 (also referred to as I/O 120), the communication system 118, and the one or more actuators 122. The I/O controller 120 is connected with other associated devices such as a display 130, at least one speaker 124, at least one actuator 126, and at least one input device 128 such as a keyboard, a mouse, a gamepad, a joystick, a touch panel, or a microphone or some other input devices. In some embodiments, the one or more actuators 126 may be embedded in one or more input devices 128, for example, a keyboard, a mouse, a gamepad, a joystick, a touch panel, or a microphone. Alternatively, the one or more actuators 126 may be directly interfaced with the electronic computing device 102.

The I/O controller 120 provides power, control information, and enables data communication between the display 130, the speaker 124, the actuator 126 (while depicted and occasionally describe as an actuator 126 or the actuator 126, this component can be multiple actuators 126), and the input device 128. Alternatively, the display 130, the speaker 124, the actuator 126, and the input device 128 can be powered by a battery or a regulated power supply. In addition, the I/O controller 120 may provide data communication to these devices through a wired or a wireless connection.

The memory 104 comprises an operating system 106, one or more applications 108, and a haptic module 110. The haptic module 110 includes computer executable instructions to produce a haptic signal from an audio signal for providing an immersive haptic experience. The haptic module 110 exchanges data and information with other components/devices such as the one or more actuators 122 and/or the one or more actuators 126. Additionally, the haptic module 110 can communicate with the cloud 140, the server 160, and the distributed system 150 through the communication system 118.

The memory 104 can be a Read-Only Memory (ROM), Random-Access Memory (RAM), digital storage, magnetic tape storage, flash storage, solid-state device storage, or some other type of storage device. The memory 104 can store encrypted instructions, source code, binary code, object code, encrypted compiled code, encoded executable code, executable instructions, assembly language code, or some other type of computer readable instructions.

In some embodiments, the haptic module 110 can be implemented as a separate module having a dedicated processor and memory. For example, the haptic module 110 may be a system-on-a-chip (SoC) or implemented in memory 104 associated with a microcontroller.

The processor 116 and the coprocessor 118 can be enabled to provide hyper-threading, multi-tasking, and multi-processing. Alternatively, the processor 116 can be a special-purpose processor or some other type of microprocessor capable of processing analog or digitalized audio signals. The processor 116 and the coprocessor 118 can implement special hardware that is designed for digital-signal processing, for example, MMX technology provided by Intel®. MMX technology provides an additional instruction set to manipulate audio, video, and multimedia. The processor 116 can any type of processor such as MMX, SSE, SSE2 (Streaming SIMD Extensions 2), SSE3 (Streaming SIMD Extensions 3), SSSE3 (Supplemental Streaming SIMD Extensions 3), SSE4 (Streaming SIMD Extensions 4) including the variants SSE 4.1 and SSE4.2, AVX (Advanced Vector Extensions), AVX2 (Haswell New Instructions), FMA (Fused multiply-add) including FMA3, SGX (Software Guard Extensions), MPX (Memory Protection Extensions), Enhanced Intel SpeedStep Technology (EIST), Intel® 64, XD bit (an NX bit implementation), Intel® VT-x, Intel® VT-d, Turbo Boost, Hyper-threading, AES-NI, Intel® TSX-NI, Intel® vPro, Intel® TXT, Smart Cache, or some other type of implementation for a processor. The processor 116 or the coprocessor 118 can be a soft processor such as the Xilinx MicroBlaze® processor that can include at least one microcontroller, real-time processor, an application processor, and the like.

The communication system 118 can interface with external devices/applications via wired or wireless communication. For example, the communication system 118 can connect to a server 160 via a wired cable. In some embodiments, the communication system 118 has an encoder, a decoder, and provides a standard interface for connecting to a wired and/or wireless network. Examples of communication interfaces include, but are not limited to, Ethernet RJ-45 interface, thin coaxial cable BNC interface and thick coaxial AUI interface, FDDI interface, ATM interface, and other network interfaces.

The cloud computing environment on the cloud 140 may include computing resources and storage. The storage may include one or more databases with at least one database having information about different actuators, devices in which actuators are embedded or associated, haptic hardware, haptic game-specific data, haptic preferences of users, and content information such as gaming information including game type.

In some embodiments, the server 160 is multi-processor, multi-threaded, with a repository comprising databases, which includes one or more databases having actuator-specific information, device-specific information, and content information for example computer games including a type of game. The distributed system 160 includes distributed databases that hold information about actuator-specific information, device-specific information, and content information such as computer games and the different attributes of the games like type, number of players, etc.

In some embodiments, the actuator-specific information is related to the specification data of the actuator. Similarly, the device-specific information may be related to specification data of the electronic computing device 102 in which the actuator is embedded. In some embodiments, the manufacturer of the actuator and the electronic computing device 102 may be different. Therefore, the specification of both the electronic computing device 102 and the actuator are required, even though the actuator is embedded in the electronic computing device 102. In preferred embodiments, the device-specific information includes the device specification along with the actuator-specific information, which is embedded in the device.

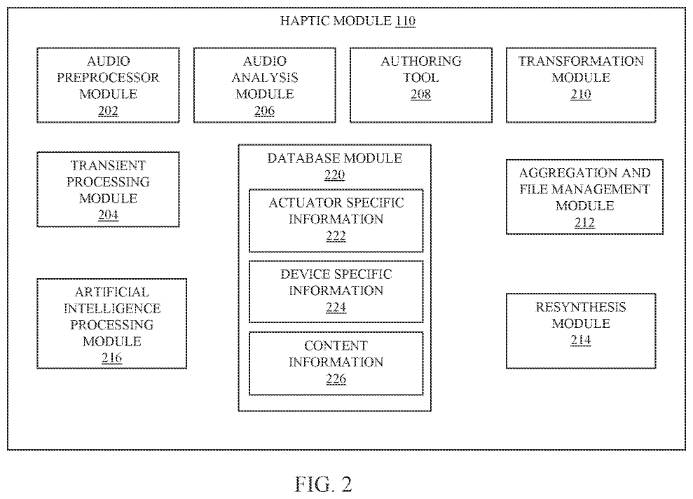

FIG. 2 illustrates different parts of a haptic module in accordance with an embodiment. The haptic module 110 includes an audio preprocessor module 202, an impulse processing module 204, an audio analysis module 206, an authoring tool 208, a transformation module 210, an aggregation and file management module 212, a resynthesis module 214, an artificial intelligence processing module 216, and a database module 220.

In some embodiments, the haptic module 110 is stored in the memory 104 of the electronic computing device 102, which can be a desktop computer, a laptop, a gaming console, a mobile computing device such as a phone or a tablet, a gaming controller such as a joystick, gamepad, flight yoke, gaming mouse, gaming keyboard, keyboard wrist rest, mouse pad, headphones, a virtual computing environment, an electronic gaming composer, a gaming editing application running on a server, or a cloud or some other computing device. In some embodiments, the resynthesis module 214 may be implemented separately in different devices, which can process haptic files to produce an immersive haptic experience (e.g., one which can be coordinated with audio data and which can be coordinated with gaming experiences such as by generating haptic data on the fly that corresponds to the audio data and/or the gaming experiences while making using of haptic data provided in a universal haptic data file format, as is described herein).

In another embodiment, the resynthesis module 214 includes a synthesizer for generating a haptic output by parsing a computer-readable file. The resynthesis module 214 may include one or more actuators connected either directly or through a mixer, which mixes an array of amplitude time values and an array of frequency time values to drive one or more actuators to provide an immersive haptic experience.

In some embodiments, the cloud 140, the server 160, the distributed system 150 may allow one or more game developers to use authoring tools concurrently, share information, share feedback, and communicate with each other for authoring games (e.g., games which can make use of universal haptic data file formats to assist with creating the immersive haptic experiences on multiple different types of devices).

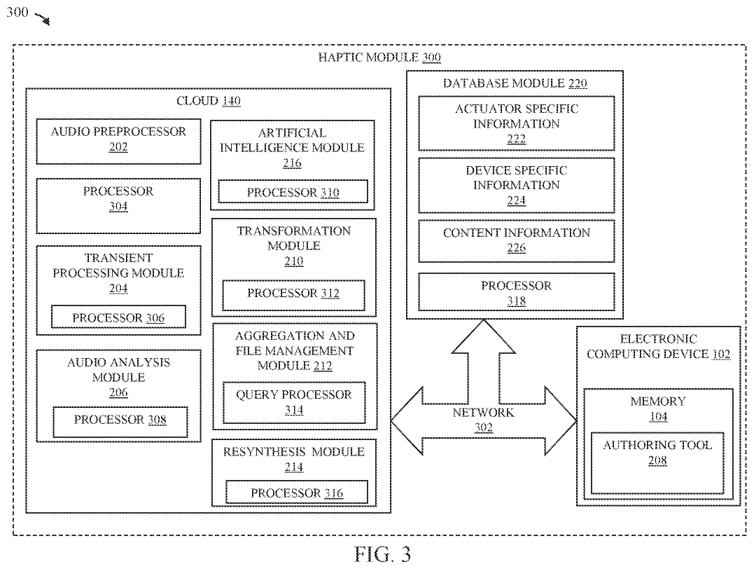

FIG. 3 illustrates different modules of a haptic module implemented in distributed environments in accordance with an embodiment. The haptic module 300 may reside on the cloud 140 or the server 160 or through the distributed system 150.

FIG. 3 shows only one implementation of the haptic module 300 with different modules distributed over the network and residing in different devices, however, there can be other implementations of the haptic module 300 having fewer or more modules residing over a network on different devices. For example, in one implementation, the audio preprocessor module 202, the impulse processing module 204, the audio analysis module 206, the artificial intelligence module 216, the transformation module 210, the aggregation and file management module 212, and the resynthesis module 214 all reside on the cloud 140. The database module 220 can have a processor 318 and associated memory, which database module 220 can be available as a distributed database over a network 302. In some embodiments, the electronic computing device 102 includes the authoring tool 208 for analyzing audio signals and authoring haptic events (e.g., events authored based on the audio signals, such as haptic outputs the correspond to the audio signals to create immersive haptic experiences).

In some embodiments, each module has a dedicated processor and memory. In different implementations, different modules may be distributed over the network 302, For example, the audio preprocessor module 202 has a processor 304, the impulse processing module 204 has a processor 306, the audio analysis module 206 has a processor 308, the artificial intelligence module 216 has a processor 310, the transformation module 210 has a processor 312, the aggregation and file management module 212 has a processor 314, and the resynthesis module 214 has a processor 316, and the authoring tool 208 can also have a processor, if the authoring tool resides outside the electronic computing device 102.

By way of example and not a limitation, in another embodiment, the audio preprocessor module 202, the impulse processing module 204, the audio analysis module 206, the artificial intelligence module 216, the transformation module 210, the aggregation and file management module 212, the resynthesis module 214, and the authoring tool 208 reside on the server 160. The database module 220 can be a distributed database or a network-implemented database available through the network 302.

Other variations and permutations are also possible for deploying different modules on different devices distributed over the network 302. For example, the audio preprocessor module 202, the impulse processing module 204, the audio analysis module 206, the artificial intelligence module 216, the transformation module 210, the aggregation and file management module 212, the resynthesis module 214, the authoring tool 208, and the database module 220 can be deployed on different devices and certain of the modules can be combined or subdivided. FIG. 3 is an exemplary illustration and should not be construed as limiting for the implementation of the haptic module 300 over the network 302.

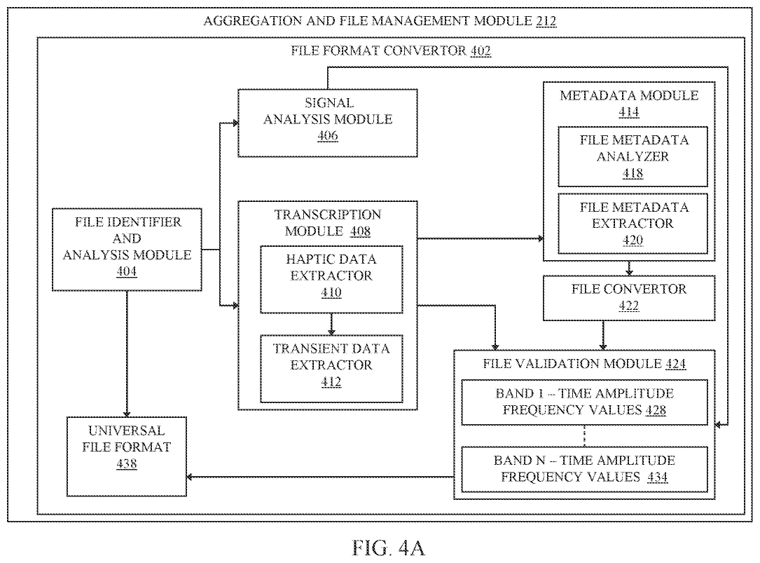

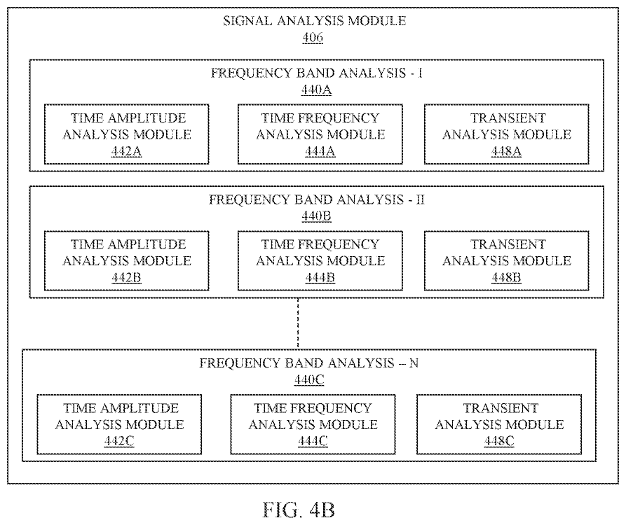

FIG. 4A illustrates a file aggregation and management module in accordance with an embodiment. The file aggregation and management module 212 includes a file format converter 402. The file format converter 402 further includes a file identifier and analysis module 404, a signal analysis module 406, a transcription module 408, a metadata module 414, a file converter module 422, a file validation module 424, and a universal file format 438.

The file identifier and analysis module 404 identifies a format of data, which data may be in form of a file, an audio file or signal, an encoded data, or other data format. For example, the data can be in a file of a .wav format, a PCM uncompressed audio, a compressed audio file .mp3 (compressed audio), .ahap format, .ivs format, or some other file format. The file identifier and analysis module 404 then identifies a type of encoded haptic data or a type of the audio file, and prepares to process a conversion of an encoded data file into a universal file format (e.g., the universal haptic data file format described herein) and can also identify other aspects related to files (e.g., file size, modification dates, etc.). If the file identifier and analysis module 404 cannot identify the file format, then it terminates and provides a message to the file aggregation and file management module 212 that the haptic file or the audio signal is in an unknown file format.

In some embodiments, the aggregation and file management module 212 may include an artificial intelligence module. The artificial intelligence module may analyze the unknown file format to decipher a type of the haptic file to assist with converting the haptic file into a universal haptic data file format by applying machine learning algorithms. The machine learning algorithms may be trained to identify haptic data embedded in files and accordingly learn to change it into the required universal haptic data file format.

In some embodiments, the file identifier and analysis module 404 initiates a process of transforming/transcripting the haptic file into a universal file format. If the file identifier and analysis module 404 has identified the type of haptic file and determines that the haptic file is already in the universal format, it passes the haptic file to universal file format 438 (FIG. 4A). Alternatively, if the file is in any audio format that is either stores compressed audio data or uncompressed audio data, then the file identifier and analysis module may pass the audio file to the signal analysis module 406. Else, the file identifier and analysis module 404 passes the haptic file to the transcription module 408, which includes a haptic data extractor 410 and a transient data extractor 412.

Referring to FIG. 4B, a block diagram of different parts of a signal analysis module is provided in accordance with an embodiment. The signal analysis module 406 may include different frequency band analyzers such as a frequency band analysis-I 440A, a frequency band analysis-II 440B, and other frequency band analysis 440C corresponding to N frequency band analysis units. In some embodiments, there may be N frequency band analysis modules, where N is a natural number. Each frequency band analysis module may include a time analysis module 442A, 442B and 442C, a time frequency analysis 444A, 444B and 444C, and a transient analysis module 448A, 448B, and 448C. The time amplitude analysis module analyses time amplitude values in an audio signal/audio data, the time frequency analysis module analyzes time frequency values and envelopes in the audio signal/audio data, and the transient analysis module analyzes the transient values in the audio signal/audio data.

The haptic data extractor 410 extracts a harmonic component or a continuous component of the haptic data from the haptic file and converts the continuous component into haptic data. Similarly, the transient data extractor 412 extracts a transient component and converts the transient component (also referred to simply as a transient) into a percussive or impulse component of the universal file format. In embodiments, the universal haptic file format may be defined using fundamental components such as frequency, amplitude, and time with transients added as impulses or emphasis with amplitude time values and/or frequency time values. For example, the fundamental components can also include components such as, but not limited to, amplitude time, frequency time, or amplitude frequency time values.

If the file format converter 402 (FIG. 4A) determines that the haptic file has been converted into the universal haptic format, then it passes the data to the file validation module 424. The file validation module 420 then evaluates if the amplitude frequency time values, amplitude time values, frequency time values have been provided for each of the frequency bands, if so, then the file validation module 424 passes the frequency band values to the universal haptic file format. However, in some embodiments, if the file validation module 424 evaluates that the amplitude frequency time values, amplitude time values, frequency time values for each frequency bands are as per required of the universal file format, then it passes the received haptic file to the universal haptic file format 438. Otherwise, the file validation module 424 extracts and arranges the amplitude frequency time values, amplitude time values, frequency time values according to each frequency band. Additionally, in some embodiments, it separates the transient haptic data and marks them with a special tag. For example, the file validation module 424 may add a tag or any indicator that provides an indication that the haptic data has to be processed as transient data.

In different embodiments, the determination that the haptic file to be converted into universal file format requires transcription or metadata analysis may be performed in the file identifier and analysis module 404 or the transcription module 408 depending upon the type and structure of the haptic file.

In at least one embodiment, the haptic file may require both transcription and metadata analysis. In this embodiment, the file format convertor 402 may process the haptic file in the transcription module 408 and the metadata module 414. If the output from the haptic data extractor 410 and the transient data extractor 412 is found to contain metadata then the haptic data file is passed to the metadata module 414. In some embodiments, the haptic file may require partial transcription analysis and partial metadata analysis and may be processed both in the transcription module 408 and the metadata module 414.

With continued reference to FIG. 4A, in some embodiments, the file metadata analyzer 418 analyzes the tags and metadata embedded in the haptic file and the file metadata extractor 420 extracts the necessary metadata to convert the haptic file into the amplitude frequency time values, amplitude time values, frequency time values. The converted amplitude frequency time values are passed to the file validation module 424. The file validation module 424 receives the extracted metadata, the haptic data, and other information from the haptic file and converts it into the amplitude frequency time values for each of the frequency bands. Finally, the file validation module 424 passes each frequency band haptic data comprising amplitude frequency time values, amplitude time values, frequency time values to the universal file converter 438.

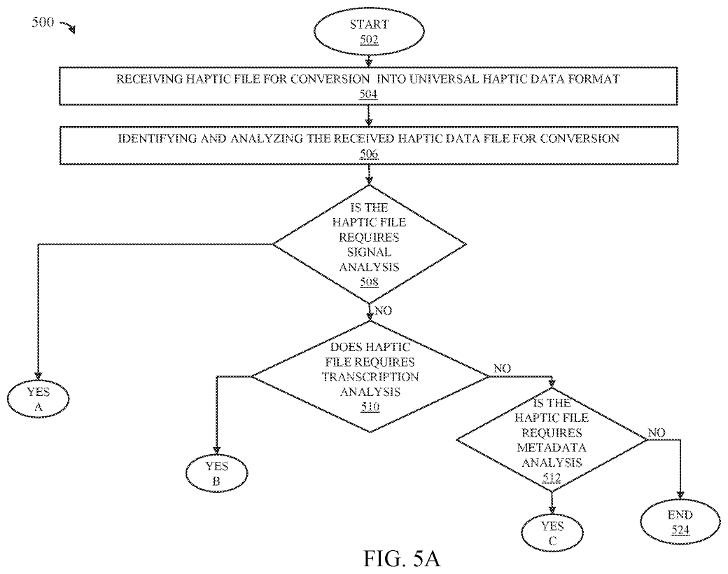

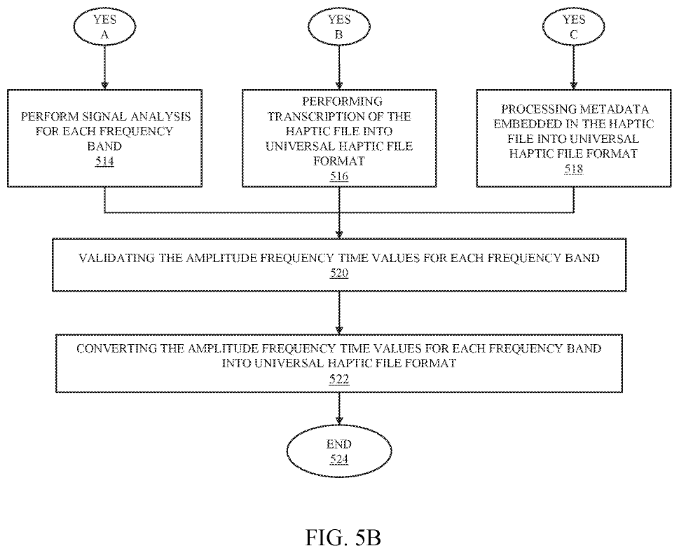

FIGS. 5A-5B illustrate an example process of converting the haptic file into a universal haptic file format in accordance with another embodiment. The process starts at step 502 and immediately moves to step 504. At step 504, the process 500 receives the haptic file or an audio file (which can include compressed audio data and/or uncompressed audio data) for conversion into the universal haptic file format.

At step 508, the identifier and analysis module 408 identifies a type of haptic file or audio file or audio data including its attribute to be converted into a universal haptic file format. Once the haptic file/audio file has been identified, the process 500 proceeds with conversion of the file into universal haptic file format, which may include signal analysis, transcription of the haptic file, or extracting metadata and converting it into the universal haptic file format. At step 508, the process 500 determines if the file requires signal analysis. If yes, then the signal analysis module 406 analyzes the signal using, e.g., a time amplitude analysis module, time frequency analysis module, and a transient analysis module. Now referring to FIG. 5B, the analysis can produce amplitude time values, frequency time values for each frequency band at step 514, which are passed to file validation module for validation of haptic data at step 520, and finally converted into a universal haptic file format at step 522. Finally the audio file is converted into the universal haptic file format and the process terminates at step 524.

However, if at step 508 (FIG. 5A), it is determined that the file is not in the audio format, then the process 500 moves to step 510, at step 510, the process 500 determines if the haptic file requires transcription. If the process 500 requires transcription the process 500 moves to 516 (FIG. 5B). At step 516, the transcription module 408 can extract haptic data by processing the haptic file in the haptic data extractor 410 and the transient data extractor 412. The extracted haptic data and the transient data is transcribed and passed to the file validation module 424. At step 518, the process 500 decomposes the amplitude frequency time values, the amplitude time values, the frequency time values for each frequency band to produce a universal haptic file.

If at step 510 (FIG. 5A), the process 500 determines that the haptic file cannot be transcribed, then the process 500 passes the step 518. At step 518 (FIG. 5B), the process 500 determines if the haptic file requires metadata analysis, if so, the process 500 passes the file to step 518. At step 518, the process 500 converts the metadata embedded in the haptic file into universal haptic file format. Subsequently, at step 520, the process 500 decomposes the amplitude frequency time values, the amplitude time values, the frequency time values for each frequency band to eventual produce a universal haptic file at step 522.

In some embodiments, the determination if the haptic file to be converted into universal haptic file format requires transcription analysis or metadata analysis may be performed in the transcription module 408. In another embodiment, the determination if the haptic file to be converted into universal haptic file format requires transcription analysis or metadata analysis may be performed in the metadata module 414.

After the haptic file data has been organized into the amplitude frequency time values for each frequency band in a structured way, the universal haptic file format is then created at step 522. Finally, the process 500 converts the amplitude frequency time values, amplitude time values, the frequency time values for each frequency band into universal haptic file format also at step 522.

The process terminates at step 524 and can be rerun to convert any number of haptic files (of any of a number of different types) into the universal haptic data file format.

In another embodiment, the process 500 extracts haptic data and the transient data from the haptic file, transcripts the haptic data and the transient data into universal haptic file format and checks if further conversion is required. If further conversion is required, the transcription module 408 can pass the haptic file to the metadata module 414. The process 500 evaluates if the file received from the transcription module 408 contains any metadata that needs to be converted into the haptic data, if so, the process 500 at step 518 converts the embedded metadata into universal file format data, which comprises amplitude frequency time values, the amplitude values, the frequency time values and then passes the haptic file to the validation module 424. At step 520, the process 500 analyzes if the haptic file has been converted into a universal haptic data format, which comprises haptic data in form of amplitude frequency time values, the amplitude time values, the frequency time values for each frequency band.

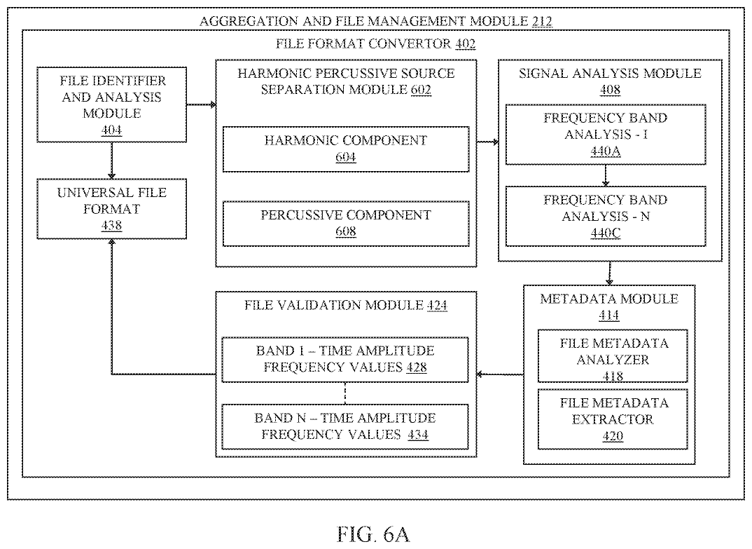

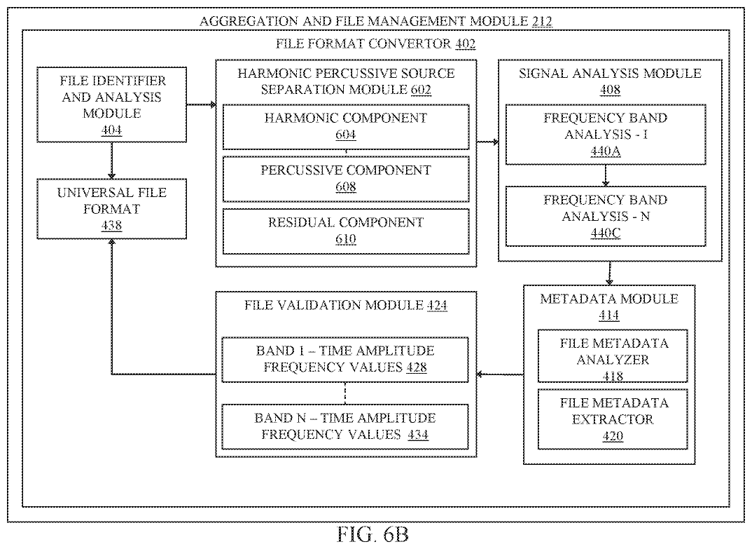

FIG. 6A illustrates a block diagram for conversion of a file into universal haptic file format in accordance with an embodiment. The block diagram includes the aggression and file management module 212. The aggregation and file management module 212 includes the file format converter 402, which further includes the file identifier and analysis module 404, a harmonic percussive source separation module 602, the signal analysis module 408, the metadata module 414, the file validation module 424, and the universal file format 438.

The file identifier and analysis module 404 passes the file comprising audio signal to the harmonic percussive source separation module 602 which includes a harmonic component 604 and a percussive component 608 (in some embodiments, this passing only occurs if it is first determined that the file being analyzed is not already in the universal file format, in which case it would not need to be passed to the module 602 for further processing and eventual conversion into the universal file format). The harmonic percussive source separation module 602 separates the harmonic component and the percussive component of the audio signal. The harmonic component 604 separates the amplitude frequency time values, the amplitude time values, the frequency time values of the continuous audio signal, and/or the harmonic component of the audio signal. Likewise, the percussive component 608 separates the amplitude frequency time values, the amplitude time values, and/or the frequency time values related to the transient signal of the audio signal. In some embodiments, the harmonic percussive source separation model 602, which includes a harmonic component 604 and a percussive component 608, identifies and separates amplitude time values and/or frequency time values, or both.

The harmonic percussive source separation module 602 passes the harmonic component and the percussive component of the audio signal to the audio analysis module 408. The audio analysis may perform an analysis of the amplitude frequency time values, the amplitude time values, and the frequency time values for each frequency band.

In some embodiments, the harmonic percussive source separation module 602 may be optional and the audio signal may be directly passed to the signal analysis module 408 (in some embodiments, whether the audio signal is directly passed to the signal analysis module 408 is based on a determination that the harmonic percussive source separation module 602 is not needed to properly analyze a file that is being converted to the universal file format).

The signal analysis module 408 can, in some embodiments, pass the analyzed audio signal to the metadata module 414. The metadata module 414 can determine if an analyzed audio signal (which can be included in a file being converted to the universal file format) contains metadata along with haptic data, which requires further processing, if so, it passes the metadata information to the metadata module 414. The metadata module 414 can include the file metadata analyzer 418 and the file metadata extractor 420. In some embodiments, the file metadata analyzer 418 analyses the metadata, structure, and haptic data and other attributes of the embedded metadata in the haptic data. The file metadata extractor 420 extracts the embedded haptic metadata values and converts them into the universal haptic file format. Alternatively, if the universal haptic format requires embedding of haptic data values, then the metadata modules 414 can embed the metadata into the haptic file. An output from the metadata module 414 is passed to the file validation module 424, which is configured to check and ensure that the amplitude frequency time values, the amplitude time values, and the frequency time values are consistent as per requirements defined for the universal haptic data file format. Finally, the haptic data is passed to the universal haptic file format 438.

In another variation, as shown in FIG. 6B, the harmonic percussive source separation module 602 comprises the harmonic component 604, the percussive component 608, and a residual component 610. The other functions and general process are the same as described above in reference to FIG. 6A. The haptic file received from the file identifier and analysis module 404 is passed to the harmonic percussive source separation module 602. In some embodiments, the harmonic percussive source separation module 602 may be optional and the audio signal may be directly passed to the signal analysis module 408.

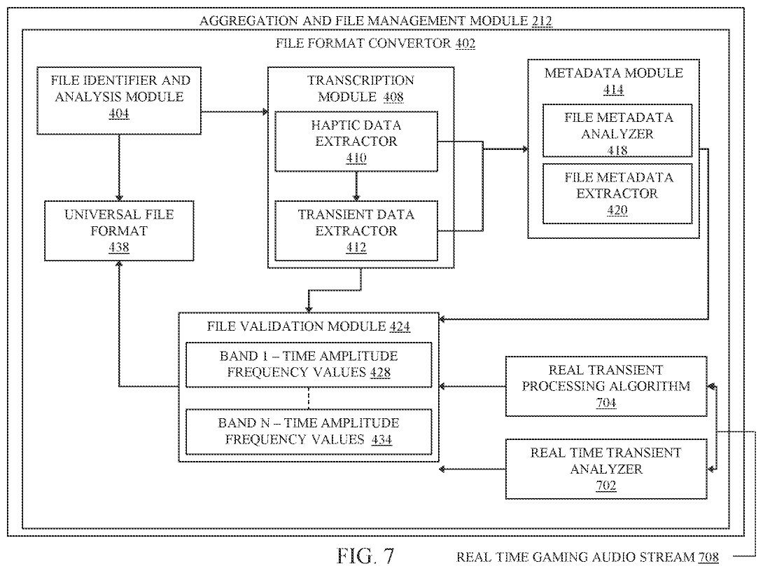

Referring now to FIG. 7, another embodiment of the aggregation and file management module 212 is provided. In this embodiment, the file format convertor 402 includes a real-time transient analyzer 702 and a real-time processing algorithm 704, which are, in this example, apart from the other modules. The real-time transient analyzer 702 is configured to analyze an audio signal for transients and identify the transients, while then passing these transients to the real-time processing algorithm 704. The real-time transient processing algorithm 704 can be configured to implement the transient-processing algorithm as provided in U.S. patent application Ser. No. 16/435,341, which is titled “Systems and Methods for Transient Processing of an Audio Signal for Enhanced Haptic Experience,” and can add transients in real time, and this commonly-owned application is also hereby incorporated by reference in its entirety.

In embodiments, the transient added in real time may occur during the authoring of the haptic data. Alternatively, in other embodiments, the real-time processing algorithm 704 may add the transient dynamically on the fly to append additional haptic effects (e.g., to the universal haptic data file) and to provide an immersive haptic experience.

In yet another embodiment, the augmentation or addition of a haptic effect to a universal haptic data file format may be in addition to transient conversion by the file format converter 402. The augmentation or addition of haptic effects may be in addition to the automated conversion of a haptic file to the universal haptic file format resulting in immersive haptic experiences that can be made available on a variety of different types of electronic devices that can make use of the same universal haptic data file format.

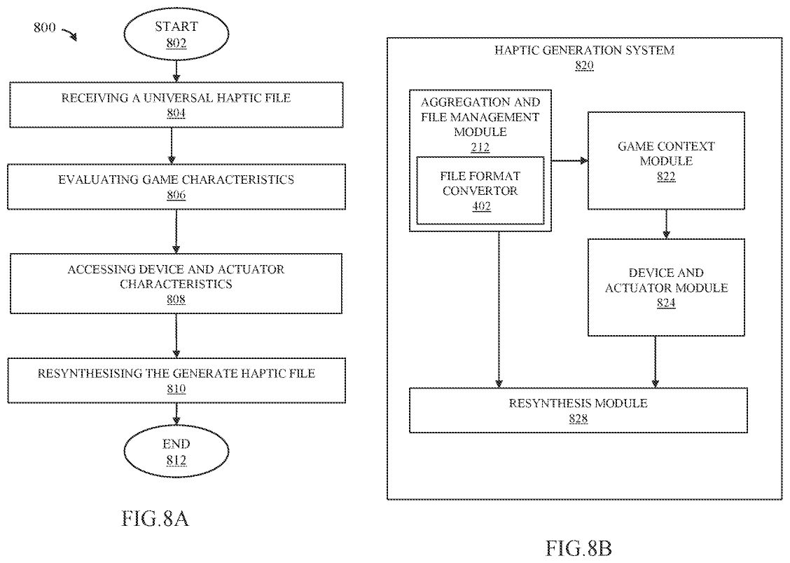

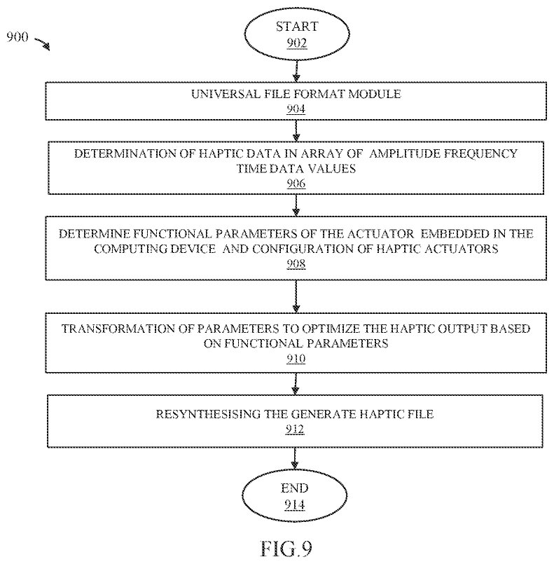

FIG. 8A illustrates a process of haptic generation by optimizing the haptic output according to device parameters in accordance with an embodiment. The process 800 starts at step 802 and immediately moves to step 804. At step 804, the process 800 receives the universal haptic file (e.g., after it was created from an input file as was described above in conjunction with the techniques described earlier, such that the process of FIG. 8 is used to further refine or add to the information included in a universal haptic data file). The universal haptic file is generated by converting a haptic file (that was original existing in any data format) using the techniques that were discussed earlier. At step 806, the process 800 evaluates different characteristics (such as associated game attributes, such as, but not limited to, type of game, user preferences, age, sex and other parameters associated with the player for a specific game). For example, whether the game is an adventure, skill, or racing game, and based on this evaluation of the game characteristics, accordingly, normalizes a haptic output. The physical and other characteristics related to a particular game may include type of game, player characteristics, player attributes, and other parameters. At step 808, the process 800 evaluates the physical and other characteristics related to the computing device and one or more actuators associated with the computing device (actuators associated with gaming headphones, a gaming controller, or other types of devices having actuators that might be used in conjunction with a game). In different embodiments, the computing device may be a mobile phone, a tablet, a laptop, a gaming console, a desktop, and the associated actuators may be an LRA, wind band actuator, or piezoelectric actuator, among others. In different embodiments, the physical characteristics associated with the actuators may be, but not limited to, type of embedded actuators, actuator characteristics such as, but not limited to, resonant frequency, nonlinear characteristics, frequency bandwidth, etc. The process 800 then determines the optimized physical, acoustic and haptic characteristics for providing an immersive haptic experience. At step 810, the process produces a universal haptic file having optimized characteristics for providing an immersive haptic experience (such as at a variety of different devices by making use of the universal haptic data file). Finally, the process 800 terminates at step 812.

Referring to FIG. 8B, a haptic generation system for adding functional parameters to a universal haptic file for immersive haptic experience (as was described above in conjunction with FIG. 8A) is provided in accordance with an embodiment. The haptic generation system 820 includes, apart from other modules in this example depiction, the aggregation and file management module 212, a game context module 822, a device and actuator module 824, and a resynthesis module 828.

The game characteristics are determined in the game context module 804. The computing device and the associated one or more actuator characteristics are evaluated in the device and actuator module 808. The game characteristics and the associated computing device and actuator characteristics are optimized in the resynthesis module 810 to produce a haptic file, which produces immersive haptic experience file or haptic output based on at least one or more parameters such as, but not limited to, the associated computing device characteristics, the actuator characteristics, the game context, and the type and number of actuators associated with the device.

The aggregation and file management module 212 produces the universal haptic file. The resynthesis module 828 evaluates different characteristics related to the associated computing device, actuators and game attributes. The game context module 804 determines the physical characteristics related to the game, for example, whether the game is adventure, skill or racing game and accordingly normalizes the haptic output. The physical and other characteristics related to game may include type of game, player characteristics, player attributes and other parameters.

The device and actuator module 824 evaluates the physical and other characteristics related to the computing device and one or more actuators. In different embodiments, the computing devices may be a phone, a tablet, a laptop, a gaming console, and a desktop and may have one or more associated actuators. In some embodiments, the associated actuator may be embedded in the computing device. The actuator characteristics may include, but are not limited to, type of embedded actuators, actuator characteristics such as, but not limited to, resonant frequency, non-linear characteristics, frequency bandwidth, etc. The system and process determine optimized physical, acoustic, and haptic characteristics for providing immersive haptics experiences. The parameters determined in the game context module 822 and the associated device and actuator module 824 are optimized in the resynthesis module 810, which produces immersive haptic experience file or haptic output based on at least one or more parameters such as but not limited to device characteristics, the actuator characteristics, the game context, and the type and number of actuators associated with the device.

In some embodiments, at least one of the actuators may be embedded in the computing device. In some embodiments, the actuator may be embedded in a haptic vest, haptic headphones, haptic belt, or a haptic suit. In other embodiments, the actuator may be indirectly associated with the computing device.

Referring to FIG. 9, in accordance with another embodiment, the universal file format is analyzed, and the functional parameters are added to produce an immersive haptic experience. The process 900 starts with accessing a universal file format module at step 902 to create a universal haptic data file, and subsequently moves to step 904. At step 904, a determination is made for a type of haptic data values embedded in the universal haptic file for each frequency band. In another implementation, an audio signal with a file (which can be input to the techniques discussed herein to then produce a universal haptic data file) may be analyzed to produce a universal haptic file, which may be utilized for adding functional parameters and to transform the haptic data to fit within bandwidth requirements of the computing device and its associated one or more actuators.

In yet another embodiment, the determination of haptic data values related to amplitude frequency time values, the amplitude time values, the frequency time values for the harmonic component, the amplitude frequency time values, the amplitude time values, and the frequency time values for percussive component is performed. This determination helps in identifying the amplitude frequency time values that are relevant and fall within the haptic bandwidth of the computing device and its associated one or more actuators. These parameters can be used to improve haptic performance during addition of functional parameters to the computing device configured to produce haptic effects (e.g., such as was described in connection with FIGS. 8A-8B).

At step 908, determining the functional parameters or the device characteristics of the computing device and the associated actuator may be performed. In some embodiments, the device characteristics may be related to the type of the one or more actuators that are associated with the computing device, the useful bandwidth of the one or more actuators, the resonant frequency of the one or more actuators, and some other similar parameters. In embodiments, the one or more actuators may be (or may include) a voice coil, a linear resonant actuator (LRA), a wideband actuator, or some other type of actuator.

At step 910, the process 900 may transform the amplitude frequency time values, the amplitude time values, and the frequency time values to optimize the haptic output based on the functional parameters of the one or more actuators (which can be embedded in the computing devices in some embodiments).

In some embodiments, the process of transformation involves fitting the haptic output within the haptic perceptual bandwidth of the one or more actuators and the computing device. The haptic perceptual bandwidth can be the bandwidth where a human can feel the vibrations on human sensory organs. The transformation process involves using a transformation algorithm to fit the time amplitude frequency values for each frequency bands into the frequency band of the one or more actuators that are embedded in the electronic computing device and/or the one or more actuators associated with the computing device. In some embodiments, the one or more actuators embedded in the computing device may be externally connected. In other embodiments, there can be one or more actuators associated with the electronic computing device. An example of a process of transformation is explained in commonly-owned U.S. provisional application No. 62/914,876, which is hereby incorporated by reference in its entirety, and the non-provisional applications that claim priority from this provisional application, which are U.S. patent application Ser. Nos. 17/069,622; 17/069,644; and Ser. No. 17/962,924, each of which is also hereby incorporated by reference in its respective entirety.

Finally, at step 912, the process 900 produces a universal haptic file that incorporates additional functional parameters and device characteristics for producing an immersive haptic experience (which immersive haptic experience can be rendered at any of several different computing devices since each of the computing devices can interpret and process the haptic data in the universal haptic file to produce consistent experiences at many different types of computing devices).

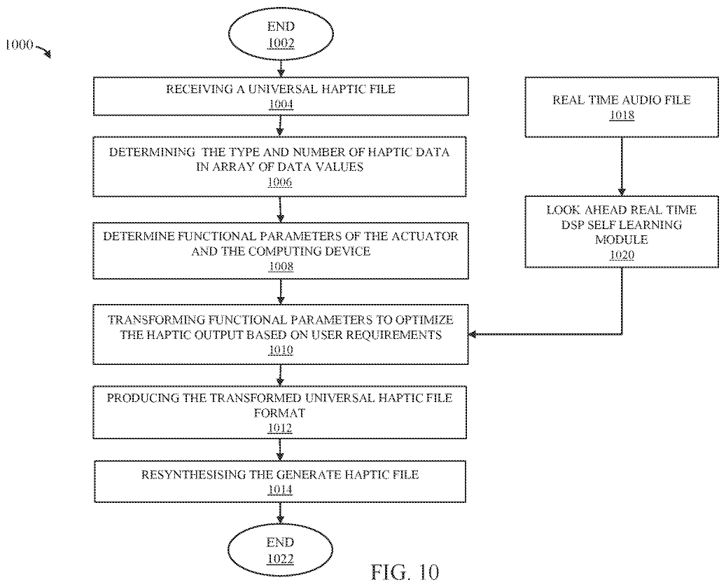

FIG. 10 illustrates a process of adding functional parameters and further adding transients parsed in real time in accordance with another embodiment.

The process is initiated at step 1002 and immediately moves to step 1004. At step 1004, the process 1000 receives a universal haptic file, which has been created from another file format (e.g., in accordance with any of the techniques discussed herein to convert an input haptic file that can include an audio signal or audio data into a universal haptic file). In some embodiments, the process 1000 may receive an audio file, analyze it, and convert it into the universal haptic format before initiating the process 1000. The haptic file can be analyzed at step 1006 to determine a type of haptic data, which type of data can be conveyed by looking at an array of amplitude frequency time values, an array of amplitude time values, and/or an array of frequency time values. The analysis provides an evaluation and assessment for associating the amplitude frequency time values and/or transforming the amplitude frequency time values with haptic perceptual bandwidth of the electronic computing devices associated with the actuator.

At step 1008 different functional parameters associated with the computing device and is associated one or more actuators are determined. Subsequently, at step 1010, the transformation algorithm performs the optimization of functional parameters based on the electronic computing device and the associated one or more actuators. In some embodiments, the user requirements may be considered by the process 1000 incorporated during the transformation of the functional parameters in the haptic file. In addition, a synchronized real-time audio stream (e.g., associated with real-time audio being played during a video game, such that this audio stream can be used to further refine the haptic effects to be provided during the video game based on information in the universal haptic file as modified by the operations of process 1000) can be received at step 1018, which is processed at step 1020 using a look-ahead real-time digital signal processing module to add transients in synchronization with haptic data. Finally, a transformation universal haptic file is created incorporating functional parameters, user requirements, and real-time transient to create an immersive haptic experience. At step 1014, the generated haptic file is resynthesized to produce an immersive haptic experience.

The process terminates at step 1022.

Although some of various drawings illustrate several logical stages in a particular order, stages which are not order dependent may be reordered and other stages may be combined or broken out. While some reordering or other groupings are specifically mentioned, others will be apparent to those of ordinary skill in the art, so the ordering and groupings presented herein are not an exhaustive list of alternatives. Moreover, it should be recognized that the stages could be implemented in hardware, firmware, software, or any combination thereof.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology. There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

Furthermore, to the extent that the term “include,” “have,” or the like is used in the description or the claims, such term is intended to be inclusive in a manner like the term “comprise” as “comprise” is interpreted when employed as a transitional word in a claim.

As used herein, the term “about” is relative to the actual value stated, as will be appreciated by those of skill in the art, and allows for approximations, inaccuracies, and limits of measurement under the relevant circumstances.

As used herein, the term “comprising” indicates the presence of the specified integer(s), but allows for the possibility of other integers, unspecified. This term does not imply any particular proportion of the specified integers. Variations of the word “comprising,” such as “comprise” and “comprises,” have correspondingly similar meanings.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method of converting a file that includes an audio signal and discrete data into a universal haptic file format, the method comprising:
analyzing content of a file that includes an audio signal and discrete data to determine a type and a format of the file, wherein an identification of the type and the format of the file includes analyzing a structure of the file and data values associated with the file;
analyzing information about the audio signal to extract amplitude time values, frequency time values, and amplitude frequency time values for each frequency band associated with the audio signal;
evaluating information about the discrete data of the file to determine if a conversion of the file into a universal haptic file format would require transcription or metadata analysis, and
in accordance with a determination that the conversion would require transcription, extracting haptic data from the file in conjunction with preparing a universal haptic file having the universal haptic file format;
in accordance with a determination that the conversion would require metadata analysis, extracting metadata from the file in conjunction with preparing the universal haptic file;
modifying the universal haptic file based on (i) a characteristic of one or more actuators associated with an electronic computing device, the one or more actuators configured to provide haptic effects using the universal haptic file while a computer game is played, and (ii) a characteristic of the computer game; and
analyzing the time amplitude frequency values for each frequency band to validate the conversion of the haptic file into the universal haptic file.

2. The method of claim 1, further comprising, processing a real-time audio stream associated with the computer game to add transients in synchronization with haptic data in the universal haptic file.

3. The method of claim 2, wherein the processing of the real-time audio stream occurs before the modifying of the universal haptic file based on (i) the characteristic of one or more actuators associated with the electronic computing device and (ii) the at least one of the characteristics of the computer game.

4. The method of claim 3, further comprising, processing the universal haptic file at the electronic computing device as the computer game is being played to provide an immersive haptic experience as the computer game is being played.

5. The method of claim 4, wherein the electronic computing device is a pair of headphones.

6. The method of claim 1, further comprising, in conjunction with preparing the universal data file, separating the information about the audio signal into a harmonic component and a percussive component.

7. The method of claim 6, wherein:
the harmonic component is associated with amplitude frequency time values, amplitude time values, and frequency time values of a continuous portion of the audio signal, and
the percussive components is associated with amplitude frequency time values, amplitude time values, and frequency time values of a transient portion of the audio signal.

8. The method of claim 1, wherein the universal haptic file is usable by multiple different types of computing devices to provide a same immersive haptic experience at each of the multiple different types of computing devices.

9. The method of claim 1, wherein each of the one or more actuators is a linear resonant actuator, a voice coil, or a wide band actuator.

10. The method of claim 1, wherein modifying the universal haptic file includes obtaining information about the characteristics of the one or more actuators from a database that is configured to dynamically receive information related to actuators provided by different vendors.

11. The method of claim 10, wherein the database is a distributed database.

12. The method of claim 1, wherein the one or more actuators are embedded in the electronic computing device.

13. The method of claim 1, wherein the characteristic of the computer game is one of a type of the computer game, player characteristics associated with the computer game, and player attributes associated with the computer game.

14. The method of claim 1, wherein the modifying of the universal haptic file is also performed such that haptic effects provided using the universal haptic file fit within a haptic perceptual bandwidth of the one or more actuators and the electronic computing device.

15. A non-transitory, computer-readable storage medium including instructions that, when executed by a computing device, cause the computing device to perform operations including:
analyzing content of a file that includes an audio signal and discrete data to determine a type and a format of the file, wherein an identification of the type and the format of the file includes analyzing a structure of the file and data values associated with the file;
analyzing information about the audio signal to extract amplitude time values, frequency time values, and amplitude frequency time values for each frequency band associated with the audio signal;
evaluating information about the discrete data of the file to determine if a conversion of the file into a universal haptic file format would require transcription or metadata analysis, and
in accordance with a determination that the conversion would require transcription, extracting haptic data from the file in conjunction with preparing a universal haptic file having the universal haptic file format;
in accordance with a determination that the conversion would require metadata analysis, extracting metadata and metadata values from the file in conjunction with preparing the universal haptic file;
modifying the universal haptic file based on (i) a characteristic of one or more actuators associated with an electronic computing device and (ii) at least one of the characteristics of a computer game; and
analyzing the time amplitude frequency values for each frequency band to validate the conversion of the haptic file into the universal haptic file.

16. A system for providing haptic effects using a universal haptic file, the system comprising:
one or more actuators configured to provide haptic effects based on data from a universal haptic file;
an electronic computing device, with which the one or more actuators are associated, configured to perform operations including:
analyzing content of a file that includes an audio signal and discrete data to determine a type and a format of the file, wherein an identification of the type and the format of the file includes analyzing a structure of the file and data values associated with the file;
analyzing information about the audio signal to extract amplitude time values, frequency time values, and amplitude frequency time values for each frequency band associated with the audio signal;
evaluating information about the discrete data of the file to determine if a conversion of the file into a universal haptic file format would require transcription or metadata analysis, and
in accordance with a determination that the conversion would require transcription, extracting haptic data from the file in conjunction with preparing the universal haptic file having the universal haptic file format;
in accordance with a determination that the conversion would require metadata analysis, extracting metadata and metadata values from the file in conjunction with preparing the universal haptic file;
modifying the universal haptic file based on (i) a characteristic of one or more actuators associated with an electronic computing device and (ii) at least one of the characteristics of a computer game; and
analyzing the time amplitude frequency values for each frequency band to validate the conversion of the haptic file into the universal haptic file.
